(19) United States
(12) Patent Application Publication
(10) Pub. No.: US 2022/0193968 A1
(43) Pub. Date: Jun. 23, 2022

(54) MARBLE-COLOR MOLDED PRODUCT AND MARBLE COLOR EFFECT EVALUATION SYSTEM

(71) Applicant: LG CHEM, LTD., Seoul (KR)

(72) Inventors: Jung Jin HAN, Daejeon (KR); Su Kyoung LEE, Daejeon (KR); Sung Hak BAE, Daejeon (KR); Ryul LEE, Daejeon (KR); Yong Ju LEE, Daejeon (KR); Hyung Sok KIM, Daejeon (KR); Sang Choll HAN, Daejeon (KR); Cho Rok MOON, Daejeon (KR); Byoung Jin KWAK, Daejeon (KR)

(21) Appl. No.: 17/600,946

(22) PCT Filed: Aug. 20, 2020
(86) PCT No.: PCT/KR2020/011111

§ 371 Date: Oct. 1, 2021

(30) Foreign Application Priority Data
Sep. 30, 2019 (KR) 10-2019-0121207

(51) Int. Cl. B29C 45/37; B29C 45/00; B29C 45/76; G01J 3/50; G01N 21/47; G01N 21/88

(52) U.S. Cl. CPC B29C 45/372; B29C 45/0001; B29C 45/76; G01J 3/504; B29K 2105/0032; G01N 21/8851; B29C 2945/7616; B29C 2945/7629; B29C 2945/76464; G01N 21/4738

(57) ABSTRACT

The present disclosure provides a marbled molded product obtained by injection-molding, in a mold cavity, a mixture including: a thermoplastic resin including one selected from the group of polycarbonate, acrylonitrile-butadiene-styrene, polybutylene terephthalate, polypropylene, and combinations thereof; and fine pigment particles, where a pattern forming a texture is formed on the surface of the injection-molded product. The present disclosure also provides a system for evaluating a marble color effect of a marbled molded product, the system including: a light source unit, an image-capturing unit, an image processing unit and an evaluation factor determination unit.

### CROSS-REFERENCE TO RELATED APPLICATIONS

The Present application is a National Phase entry pursuant to 35 U.S.C. § 371 of International Application No. PCT/KR2020/011111, filed on Aug. 20, 2020, and claims the benefit of and priority to Korean Patent Application No. 10-2019-0121207, filed on Sep. 30, 2019, in the Korean Intellectual Property Office, the entire content of which are incorporated by reference in their entirety for all purposes as if fully set forth herein.

### TECHNICAL FIELD

The present invention relates to a marbled molded product and a system for evaluating a marble color effect.

### BACKGROUND ART

Engineering plastics (EP) such as polycarbonate resin, acrylonitrile-butadiene-styrene (ABS), and the like, which are thermoplastic resin plastics, are widely used as materials for IT home appliances, automotive parts and the like due to their excellent mechanical and thermal properties.

In order to create a pattern on the exterior of an injection-molded plastic product, an application process such as spraying, coating or plating is generally performed on the top surface of the injection-molded plastic product. However, this application process causes environmental problems due to an adhesive used in this process and volatile organic compounds (VOCs) generated in a washing process. In addition, this application process has problems in that, since it is performed through a number of complex steps, the defect rate therein increases, and in that considerable logistics costs are incurred, such as separate costs for transport to the application process and a packaging process after injection molding of the plastic product.

Accordingly, there is an increasing demand for creating a pattern on the exterior of a plastic product without using an application process, and studies have been actively conducted to create a metal look, an artificial marble pattern or the like using pearl, metallic particles, pigment particles, etc. Among them, the artificial marble pattern is collectively referred to as a marble color. Until now, a mold pattern for effectively forming the marble color and a system for evaluating a marble color effect have not been specifically proposed.

Here, the expression “it can be seen that the marble color has been effectively formed” means that the marbled region can be well viewed omnidirectionally even if the marbled molded product is viewed from various orientations.

Meanwhile, a marbled molded product formed without using the application process generally tends to have a lower surface hardness than a molded plastic article having a coating layer formed using the application process, and hence a mold pattern for improving the surface hardness is also required.

The above-described background art is technical information which has been possessed by the present inventors to derive embodiments of the present invention or has been acquired in the course of deriving the embodiments of the present invention, and the background art is not necessarily considered a well-known art opened to the general public prior to filing of embodiments of the present invention.

### DISCLOSURE

### Technical Problem

The present invention has been made in order to solve the above-described problems, and an object of the present invention is to provide a marbled molded product in which a marble color may be effectively formed and which may maintain a high surface hardness, and a marble color effect evaluation system which is a system for evaluating the marble color effect of the surface of the marbled molded product.

However, the objects to be solved by the present invention are not limited to the above-mentioned object, and other objects which are not mentioned herein will be clearly understood by those skilled in the art from the following description.

### Technical Solution

One embodiment of the present invention provides a marbled molded product which is an injection-molded product of a mixture comprising: a thermoplastic resin comprising one selected from the group consisting of polycarbonate, acrylonitrile-butadiene-styrene, polybutylene terephthalate, polypropylene, and combinations thereof; and fine pigment particles, wherein a pattern forming a texture is formed on the surface of the injection-molded product.

According to one embodiment of the present invention, the pattern that is formed on the surface of the molded product may have a depth of 100 nm to 1,000 μm.

According to one embodiment of the present invention, the average roughness (Ra) of the surface of the molded product, which has the pattern formed thereon, may be 1.12 μm to 12.5 μm.

According to one embodiment of the present invention, the pattern may have a depth of 10 μm to 50 μm and a width of 50 μm to 300 μm, and the texture formed by the pattern may be a hairline texture.

According to one embodiment of the present invention, the pattern may have a depth of 8 μm to 12 μm and a width of 50 μm to 100 μm, and the texture formed by the pattern may be a woven texture.

According to one embodiment of the present invention, the pattern may have a depth of 50 μm to 100 μm, and the texture formed by the pattern may be a leather texture.

Another embodiment of the present invention provides a system for evaluating a marble color effect of a marbled molded product which is an injection-molded product of a mixture comprising: a thermoplastic resin comprising one selected from the group consisting of polycarbonate, acrylonitrile-butadiene-styrene, polybutylene terephthalate, polypropylene, and combinations thereof; and fine pigment particles, the system comprising: a light source unit configured to emit light onto the surface of the molded product while forming an angle with the surface of the molded product; an image-capturing unit configured to capture an image of light scattered from the surface of the molded product; an image processing unit configured to process the image captured by the image-capturing unit in order to determine the boundaries of regions in which the marble color effect is created on the surface of the molded product; and an evaluation factor determination unit configured to determine a marble color effect evaluation factor from the image processed by the image processing unit, wherein the marble color effect evaluation factor is at least one of: the number of the regions in which the marble color effect is created; the size of the regions in which the marble color effect is created; and a difference in average color brightness between the regions in which the marble color effect is created and a region in which the marble color effect is not created.

According to one embodiment of the present invention, the evaluation factor determination unit may determine the marble color effect evaluation factor for each color of the regions in which the marble color effect is created.

### Advantageous Effects

The marbled molded product according to one embodiment of the present invention may be a marbled molded product in which a marble color may be effectively formed and which may maintain a high surface hardness.

The marble color effect evaluation system according to one embodiment of the present invention may quantitatively evaluate the marble color effect of the surface of the marbled molded product by determining an evaluation factor that may quantitatively determine the marble color effect.

The effects of the present invention are not limited to the above-described effects, and effects which are not mentioned herein will be clearly understood by those skilled in the art from the present specification and the accompanying drawings.

### BRIEF DESCRIPTION OF DRAWINGS

FIG. 1 shows a captured image of an example of a marbled molded product produced using an embodiment of a mold cavity having a hairline texture pattern, and an enlarged microscopic image of the surface of the marbled molded product.

FIG. 2 shows a captured image of an example of a marbled molded product produced using an embodiment of a mold cavity having a woven texture pattern, and an enlarged microscopic image of the surface of the marbled molded product.

FIG. 3 shows a captured image of an example of a marbled molded product produced using an embodiment of a mold cavity having a leather texture pattern, and an enlarged microscopic image of the surface of the marbled molded product.

FIG. 4 is a schematic view showing a marble color effect evaluation system according to one embodiment of the present invention.

FIG. 5(a) shows an example of an image before being processed by an image processing unit, and FIG. 5(b) shows an image obtained by processing the image of FIG. 5(a) by the image processing unit according to a predetermined reference.

FIGS. 6(a), 6(b), 6(c), 6(d) and 6(e) show images of specimens of Comparative Example 1, Comparative Example 2, Example 1, Example 2 and Example 3, respectively, captured by an image-capturing unit 20 of a marble color effect evaluation system 100 according to one embodiment of the present invention.

### DETAILED DESCRIPTION

The present invention will become apparent with reference to embodiments described below in detail together with the accompanying drawings. However, the present invention is not limited to the embodiments disclosed below and may be embodied in a variety of different forms. Rather, these embodiments are provided in order for this disclosure to be thorough and complete, and in order to fully convey the scope of the present invention to those skilled in the art, and the scope of the present invention will be defined only by the appended claims. Meanwhile, terms used in the present specification serve to explain embodiments and are not intended to limit the scope of the present invention. In this specification, singular forms also include plural forms unless specifically stated in the context thereof. As used in the specification, the terms “comprises” and/or “comprising” specify the presence of stated elements, steps, operations and/or components, but do not preclude the presence or addition of one or more other elements, steps, operations and/or components. Although terms such as “first” and “second” may be used to describe various components, the components should not be limited by these terms. These terms are used only to distinguish one component from another component.

Throughout the present specification, it is to be understood that when any part is referred to as “comprising” any component, it does not exclude other components, but may further comprise other components, unless otherwise specified.

Throughout the present specification, when any member is referred to as being “on” another member, it not only refers to a case where any member is in contact with another member, but also a case where a third member exists between the two members.

Throughout the present specification, “A and/or B” refers to “A and B” or “A or B”.

Hereinafter, the present invention will be described in more detail.

One embodiment of the present invention provides a marbled molded product which is an injection-molded product of a mixture comprising: a thermoplastic resin comprising one selected from the group consisting of polycarbonate, acrylonitrile-butadiene-styrene, polybutylene terephthalate, polypropylene, and combinations thereof; and fine pigment particles, wherein a pattern forming a texture is formed on the surface of the injection-molded product.

The marbled molded product according to one embodiment of the present invention may be a marbled molded product in which a marble color may be effectively formed and which may maintain a high surface hardness.

According to one embodiment of the present invention, the marbled molded product comprises a thermoplastic resin comprising one selected from the group consisting of polycarbonate, acrylonitrile-butadiene-styrene, polybutylene terephthalate, polypropylene, and combinations thereof. Specifically, the thermoplastic resin may be a resin comprising only any one of polycarbonate (PC), acrylonitrile-butadiene-styrene (ABS), polybutylene terephthalate (PBT) and polypropylene (PP), or may comprise one selected from the group consisting of polycarbonate (PC), acrylonitrile-butadiene-styrene (ABS), polybutylene terephthalate (PBT), polypropylene (PP), and combinations thereof. By selecting the material of the thermoplastic resin from those described above, it is possible to improve the compatibility of the thermoplastic resin with the fine pigment particles, and at the same time, improve the workability thereof during injection molding.

According to one embodiment of the present invention, the marbled molded product comprises fine pigment particles. Where the marbled molded product comprises the fine pigment particles as described above, it is possible to improve the marble color effect on the surface of the marbled molded product. In the present specification, the marble color effect may refer to a marble shape and/or form created by exposure of the fine pigment particles to the surface of the thermoplastic resin, and the marble may be artificial marble.

According to one embodiment of the present invention, the size of the fine pigment particles may be 25 μm to 2,000 μm, 50 μm to 1,900 μm, 100 μm to 1,800 μm, 200 μm to 1,700 μm, 300 μm to 1,600 μm, 400 μm to 1,500 μm, 500 μm to 1,400 μm, 600 μm to 1,300 μm, 700 μm to 1,200 μm, 800 μm to 1,100 μm, or 900 μm to 1,000 μm. By adjusting the size of the fine pigment particles within the above-described range, it is possible to improve the visibility of the fine pigment particles.

According to one embodiment of the present invention, the fine pigment particles may be used as such without being coated with a separate dye. Where the fine pigment particles are used as such without being coated with a separate dye as described above, it is possible to create a marble color as the intrinsic color of the fine pigment particles.

According to one embodiment of the present invention, the fine pigment particles may be coated with an organic dye and/or an inorganic dye. By coating the fine pigment particles with an organic dye and/or an inorganic dye as described above, it is possible to create a marble color as a color different from the intrinsic color of the fine pigment particles, and at the same time, impart the physical properties of the fine pigment particles to the marbled molded product and improve the compatibility between the thermoplastic resin and the fine pigment particles.

According to one embodiment of the present invention, the shape of the fine pigment particles may be one selected from the group consisting of a plate shape, a cylindrical shape (pillar shape), a flake shape, and combinations thereof. By selecting the shape of the fine pigment particles from those described above, it is possible to improve the marble color effect of the marbled molded product.

According to one embodiment of the present invention, the fine pigment particles may comprise one selected from the group consisting of plate-shaped mica, cellulose, viscose, aluminum (Al), pearl, and combinations thereof. By selecting the fine pigment particles from those described above, it is possible to improve the marble color effect of the marbled molded product.

According to one embodiment of the present invention, the marbled molded product is an injection-molded product of a mixture comprising the thermoplastic resin and the fine pigment particles. Specifically, the marbled molded product is a molded product produced by heating and melting a mixture comprising the thermoplastic resin and the fine pigment particles, and then injecting the melt into a mold cavity. On the other hand, the marbled molded product may be a molded product produced by injecting an extruded product comprising the thermoplastic resin and the fine pigment particles into a mold cavity. Where the marbled molded product is produced using an injection-molded product of a mixture comprising the thermoplastic resin and the fine pigment particles as described above, it is possible to simplify the process of producing the marbled molded product and mass-produce the marbled molded product by shortening the production time of the marbled molded product.

According to one embodiment of the present invention, the marbled molded product may be an injection-molded product having, on the surface thereof, a pattern forming a texture. More specifically, the texture created on the surface of the injection-molded product may be a hairline texture, a woven texture, or a leather texture.

Furthermore, the surface of molded product may refer to a portion exposed to the outside, that is, the air-contacting surface of the molded product, and may refer to the entire surface or a partial surface of the molded product. Where the pattern forming a texture is provided on the surface of the injection-molded product as described above, it is possible to improve the aesthetics of the marbled molded product, and to eliminate the need for separate painting or coating on the surface of the molded product, thus preventing painting or coating on the surface of the molded product from peeling off.

Furthermore, in the case of a marbled molded product in which the surface of the molded product is smooth (no pattern is formed on the surface), the degree of visibility of the marble color may vary greatly depending on a direction in which the surface is viewed. This is because the size, density, color brightness and the like of the fine pigment particles distributed on the surface of the marbled molded product thus produced are not uniform throughout to the entire area, and thus variation in the degree of diffused reflection of light incident on the surface of the marbled molded product may be different depending on the direction in which the surface is viewed. Therefore, where the pattern forming a texture is provided on the surface of the marbled molded product, even if the size, density, color brightness, etc. of the fine pigment particles distributed on the surface of the marbled molded product are not uniform throughout the entire area, it is possible to reduce variation in the degree of diffused reflection of light, incident on the surface of the marbled molded product by the transferred pattern, so as to be able to be distributed relatively evenly on the corresponding surface, and it is also possible to reduce variation in the degree of visibility of the marble color depending on the direction in which the surface is viewed.

According to one embodiment of the present invention, the width and/or depth of the pattern formed on the surface of the molded product may be 0.1 nm to 1,000 μm. Specifically, the width and/or depth of the pattern formed on the surface of the molded product may be 1 nm to 900 μm, 10 nm to 800 μm, 100 nm to 500 μm, 500 nm to 300 μm, 800 nm to 200 μm, 1 μm to 100 μm, 10 μm to 90 μm, 20 μm to 80 μm, or 30 μm to 50 μm. More specifically, the pattern formed on the surface of the molded product may have a depth and/or a width on the order of nanometers to micrometers. That is, the depth and/or width of the pattern may be determined within a range that may improve the degree of visibility of the marble color and/or the hardness of the surface to a desired level depending on the type, shape and size of the fine pigment particles. Where the width and/or depth of the pattern formed on the surface of the molded product are/is adjusted within the above-described range, it is possible to improve the visibility of the fine pigment particles exposed to the pattern.

According to one embodiment of the present invention, the average roughness (Ra) of the surface of the molded product, which has the pattern formed thereon, may be 1.12 μm to 12.5 μm. Specifically, the average roughness (Ra) of the surface of the molded product, which has the pattern formed thereon, may be 1 μm to 15 μm, 2 μm to 14 μm, 3 μm to 13 μm, 4 μm to 12 μm, 5 μm to 11 μm, 6 μm to 10 μm, or 7 μm to 9 μm. Where the average roughness (Ra) of the surface of the molded product, which has the pattern formed thereon, is adjusted within the above-described range, it is possible to improve the marble color effect of the surface of the marbled molded product and improve the visibility of the fine pigment particles.

FIG. 1 shows a captured image of an example of a marbled molded product produced using an embodiment of a mold cavity having a hairline texture pattern, and an enlarged microscopic image of the surface of the marbled molded product.

According to one embodiment of the present invention, when the texture formed by the pattern is a hairline texture, the depth of the pattern may be 10 μm to 50 μm. Specifically, when the texture formed by the pattern is a hairline texture, the depth of the pattern may be 12 μm to 48 μm, 14 μm to 46 μm, 16 μm to 44 μm, 18 μm to 42 μm, 20 μm to 40 μm, 22 μm to 38 μm, 24 μm to 36 μm, 26 μm to 34 μm, or 28 μm to 32 μm. Furthermore, when the texture formed by the pattern is a hairline texture, the width of the pattern may be 50 μm to 300 μm. Specifically, when the texture formed by the pattern is a hairline texture, the width of the pattern may be 50 μm to 300 μm, 75 μm to 275 μm, 100 μm to 250 μm, 125 μm to 225 μm, or 150 μm to 200 μm. Where the width and/or depth of the pattern is adjusted within the above-described range when the texture formed by the pattern is a hairline texture, it is possible to enlarge a portion where the fine pigment particles are exposed to the pattern formed on the surface of the marbled molded product, and it is possible to increase the hardness of the surface by improving compatibility with the marbled molded product.

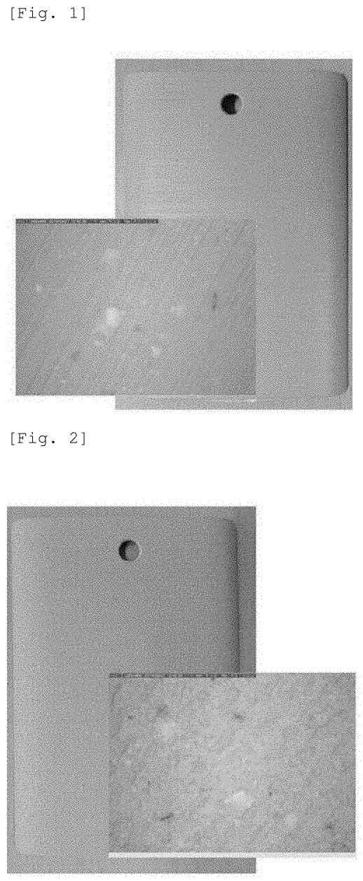

FIG. 2 shows a captured image of an example of a marbled molded product produced using an embodiment of a mold cavity having a woven texture pattern, and an enlarged microscopic image of the surface of the marbled molded product.

According to one embodiment of the present invention, when the texture formed by the pattern is a woven texture, the depth of the pattern may be 8 μm to 12 μm. Specifically, when the texture formed by the pattern is a woven texture, the depth of the pattern may be 8 μm to 12 μm, 8.5 μm to 11.5 μm, 9 μm to 11 μm, or 9.5 μm to 10.5 μm. Furthermore, when the texture formed by the pattern is a woven texture, the width of the pattern may be 50 μm to 100 μm. Specifically, when the texture formed by the pattern is a woven texture, the width of the pattern may be 55 μm to 95 μm, 60 μm to 90 μm, 65 μm to 85 μm, or 70 μm to 80 μm. Where the width and/or depth of the pattern is adjusted within the above-described range when the texture formed by the pattern is a woven texture, it is possible to improve visibility by enlarging a portion where the fine pigment particles are exposed to the pattern formed on the surface of the marbled molded product, and it is possible to increase the hardness of the surface by improving compatibility with the marbled molded product.

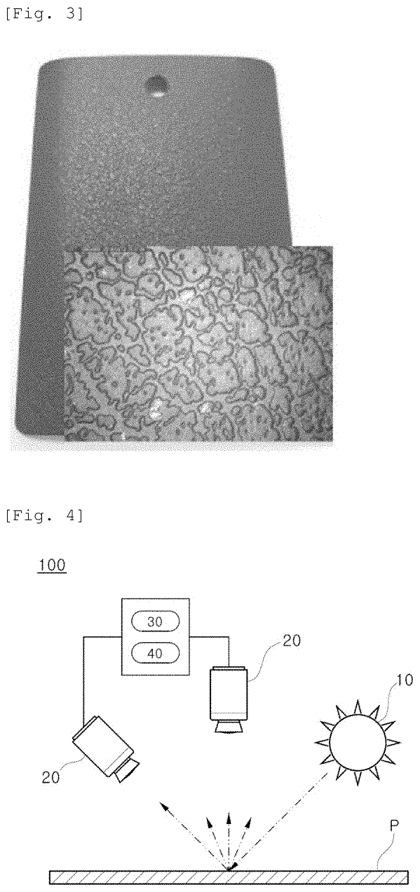

FIG. 3 shows a captured image of an example of a marbled molded product produced using an embodiment of a mold cavity having a leather texture pattern, and an enlarged microscopic image of the surface of the marbled molded product.

According to one embodiment of the present invention, when the texture formed by the pattern is a leather texture, the depth of the pattern may be 50 μm to 100 μm. Specifically, when the texture formed by the pattern is a leather texture, the depth of the pattern may be 55 μm to 95 μm, 60 μm to 90 μm, 65 μm to 85 μm, or 70 μm to 80 μm. Where the depth of the pattern is adjusted within the above-described range when the texture formed by the pattern is a leather texture, it is possible to improve visibility by enlarging a portion where the fine pigment particles are exposed to the pattern formed on the surface of the marbled molded product, and it is possible to increase the hardness of the surface by improving compatibility with the marbled molded product.

One embodiment of the present invention provides a mold for producing a marbled molded product in which a pattern is formed on the inner surface of a cavity. The mold for producing a marbled molded product according to one embodiment of the present invention may effectively form a marble color and may improve the surface hardness of the marbled molded product.

According to one embodiment of the present invention, a mixture comprising a thermoplastic resin comprising one selected from the group consisting of polycarbonate, acrylonitrile-butadiene-styrene, polybutylene terephthalate, polypropylene, and combinations thereof, and fine pigment particles may be injected into and fill the interior of the cavity of the mold, and then molded. According to another embodiment of the present invention, an extruded product comprising the thermoplastic resin and the fine pigment particles may be injected into the cavity of the mold. Where the molded product is produced by injecting a melt of the mixture into the cavity of the mold, it is possible to produce a molded product whose marble color effect has been created, and it is possible to mass-produce the molded product by shortening the production time.

In the present specification, description of the features of the mold, which overlap those of the marbled molded product, will be omitted.

According to one embodiment of the present invention, a pattern may be formed on the inner surface of the cavity of the mold. Where a pattern is formed on the inner surface of the cavity of the mold as described above, it is possible to improve the marble color effect by transferring the pattern, formed on the inner surface of the cavity of the mold, to the surface of the molded product. Specifically, in the case of a marbled molded product obtained by injection molding through a mold cavity having a smooth inner surface, the degree of visibility of the marble color may vary greatly depending on the direction in which the surface is viewed. This is because the size, density, color brightness and the like of the fine pigment particles distributed on the surface of the marbled molded product thus produced are not uniform throughout to the entire area, and thus variation in the degree of diffused reflection of light incident on the surface of the marbled molded product may be different depending on the direction in which the surface is viewed.

According to one embodiment of the present invention, a pattern forming a texture may be formed on the inner surface of the mold cavity. Where the pattern is transferred onto the surface of the marbled molded product, even if the average size, density, color brightness, etc. of the fine pigment particles distributed on the surface of the marbled molded product are not uniform throughout the entire area, it is possible to reduce variation in the degree of diffused reflection of light, incident on the surface of the marbled molded product by the transferred pattern, so as to be able to be distributed relatively evenly on the corresponding surface, and it is also possible to reduce variation in the degree of visibility of the marbled molded product depending on the direction in which the surface is viewed.

According to one embodiment of the present invention, the width and/or depth of the pattern formed on the inner surface of the mold cavity may be 100 nm to 1,000 μm. Specifically, the width and/or depth of the pattern formed on the inner surface of the mold cavity may be 150 nm to 900 μm, 300 nm to 800 μm, 500 nm to 500 μm, 800 nm to 300 μm, 900 nm to 200 μm, 1 μm to 100 μm, 10 μm to 90 μm, 20 μm to 80 μm, or 30 μm to 50 μm. Specifically, the width and/or depth of the pattern formed on the inner surface of the mold cavity may be a depth and/or a width on the order of nanometers to micrometers. The width and/or depth of the pattern formed on the inner surface of the mold cavity may be determined within a range that may improve the degree of visibility of the marble color and/or the hardness of the surface to a desired level depending on the type, shape and size of the fine pigment particles. Where the width and/or depth of the pattern formed on the inner surface of the mold cavity are/is adjusted within the above-described range, it is possible to adjust the width and/or depth of the pattern formed on the marbled molded product by transfer of the pattern onto the inner surface of the mold cavity and to improve the visibility of the fine pigment particles.

According to one embodiment of the present invention, the average roughness (Ra) of the inner surface of the mold cavity, which has the pattern formed thereon, may be 1.12 μm to 12.5 μm. More specifically, the average roughness (Ra) of the inner surface of the mold cavity, which has the pattern formed thereon, may be 1 μm to 15 μm, 2 μm to 14 μm, 3 μm to 13 μm, 4 μm to 12 μm, 5 μm to 11 μm, 6 μm to 10 μm, or 7 μm to 9 μm. Where the average roughness of the inner surface of the mold cavity, which has the pattern formed thereon, is adjusted within the above-described range, it is possible to improve the marble color effect of the surface of the marbled molded product by transfer of the pattern and improve the visibility of the fine pigment particles.

According to one embodiment of the present invention, when the texture of the inner surface of the mold cavity, which has the pattern formed thereon, is a hairline texture, the depth of the pattern may be 10 μm to 50 μm. Specifically, when the texture of the inner surface of the mold cavity, which has the pattern formed thereon, is a hairline texture, the depth of the pattern may be 12 μm to 48 μm, 14 μm to 46 μm, 16 μm to 44 μm, 18 μm to 42 μm, 20 μm to 40 μm, 22 μm to 38 μm, 24 μm to 36 μm, 26 μm to 34 μm, or 28 μm to 32 μm. Furthermore, when the texture of the inner surface of the mold cavity, which has the pattern formed thereon, is a hairline texture, the width of the pattern may be 50 μm to 300 μm. Specifically, when the texture of the inner surface of the mold cavity, which has the pattern formed thereon, is a hairline texture, the width of the pattern may be 50 μm to 300 μm, 75 μm to 275 μm, 100 μm to 250 μm, 125 μm to 225 μm, or 150 μm to 200 μm. Where the width and/or depth of the pattern are/is adjusted within the above-described range when the texture of the inner surface of the mold cavity, which has the pattern formed thereon, is a hairline texture, it is possible to enlarge a portion where the fine pigment particles are exposed to the pattern formed on the surface of the marbled molded product, and it is possible to increase the hardness of the surface by improving compatibility with the marbled molded product.

According to one embodiment of the present invention, when the texture of the inner surface of the mold cavity, which has the pattern formed thereon, is a woven texture, the depth of the pattern may be 8 μm to 12 μm. Specifically, when the texture of the inner surface of the mold cavity, which has the pattern formed thereon, is a woven texture, the depth of the pattern may be 8 μm to 12 μm, 8.5 μm to 11.5 μm, 9 μm to 11 μm, or 9.5 μm to 10.5 μm. Furthermore, when the texture of the inner surface of the mold cavity, which has the pattern formed thereon, is a woven texture, the width of the pattern may be 50 μm to 100 μm. Specifically, when the texture of the inner surface of the mold cavity, which has the pattern formed thereon, is a woven texture, the width of the pattern may be 55 μm to 95 μm, 60 μm to 90 μm, 65 μm to 85 μm, or 70 μm to 80 μm. Where the width and/or depth of the pattern are/is adjusted within the above-described range when the texture of the inner surface of the mold cavity, which has the pattern formed thereon, is a woven texture, it is possible to improve visibility by enlarging a portion where the fine pigment particles are exposed to the pattern formed on the surface of the marbled molded product, and it is possible to increase the hardness of the surface by improving compatibility with the marbled molded product.

According to one embodiment of the present invention, when the texture of the inner surface of the mold cavity, which has the pattern formed thereon, is a leather texture, the depth of the pattern may be 50 μm to 100 μm. Specifically, when the texture of the inner surface of the mold cavity, which has the pattern formed thereon, is a leather texture, the depth of the pattern may be 55 μm to 95 μm, 60 μm to 90 μm, 65 μm to 85 μm, or 70 μm to 80 μm. Where the depth of the pattern is adjusted within the above-described range when the texture of the inner surface of the mold cavity, which has the pattern formed thereon, is a leather texture, it is possible to improve visibility by enlarging a portion where the fine pigment particles are exposed to the pattern formed on the surface of the marbled molded product, and it is possible to increase the hardness of the surface by improving compatibility with the marbled molded product.

One embodiment of the present invention is directed to a method for producing a marbled molded product, in which the marbled molded product may be produced by injecting, into a mold cavity, an extruded product of a mixture comprising: a thermoplastic resin comprising one selected from the group consisting of polycarbonate, acrylonitrile-butadiene-styrene, polybutylene terephthalate, polypropylene, and combinations thereof; and fine pigment particles. In another embodiment, a marbled molded product may be produced by injecting, into a mold cavity, a melt of a mixture comprising: a thermoplastic resin comprising one selected from the group consisting of polycarbonate, acrylonitrile-butadiene-styrene, polybutylene terephthalate, polypropylene, and combinations thereof; and fine pigment particles.

The method for producing a marbled molded product according to one embodiment of the present invention may be a method for producing a marbled molded product in which a marble color may be effectively formed and which may maintain a high surface hardness.

In the present specification, description of the features of the method for producing a marbled molded product, which overlap those of the marbled molded product, will be omitted.

According to one embodiment of the present invention, the temperature of the injection molding process may be 230° C. to 320° C. Specifically, the temperature of the injection molding process may be 240° C. to 310° C., 250° C. to 300° C., 260° C. to 290° C., or 270° C. to 280° C. By adjusting the temperature of the injection molding process within the above-described range, it is possible to improve the fillability of the mold cavity by adjusting the viscosity of the melt of the mixture in the injection molding process.

According to one embodiment of the present invention, the mixture comprising the thermoplastic resin and the fine pigment particles may be injection-molded. Specifically, a melt formed by heating and melting the mixture comprising the thermoplastic resin and the fine pigment particles may be injection-molded in a mold cavity. Where the mixture comprising the thermoplastic resin and the fine pigment particles is injection-molded as described above, it is possible to produce a molded product onto which the pattern provided on the inner surface of the mold cavity has been transferred. More specifically, the molded product produced by the above production method may have an artificial marble pattern, that is, a marble color.

According to one embodiment of the present invention, an extruded product formed by mixing the thermoplastic resin with the fine pigment particles may be injection-molded in a mold cavity. Where the extruded product formed by mixing the thermoplastic resin with the fine pigment particles is injection-molded in the mold cavity, it is possible to produce a molded product having an artificial marble pattern.

One embodiment of the present invention provides a system 100 for evaluating a marble color effect of a marbled molded product which is an injection-molded product of a mixture comprising: a thermoplastic resin comprising one selected from the group consisting of polycarbonate, acrylonitrile-butadiene-styrene, polybutylene terephthalate, polypropylene, and combinations thereof; and fine pigment particles, the system comprising: a light source unit 10 configured to emit light onto the surface of the molded product while forming an angle with the surface of the molded product; an image-capturing unit 20 configured to capture an image of light scattered from the surface of the molded product; an image processing unit 30 configured to process the image captured by the image-capturing unit in order to determine the boundaries of regions in which the marble color effect is created on the surface of the molded product; and an evaluation factor determination unit 40 configured to determine a marble color effect evaluation factor from the image processed by the image processing unit 30, wherein the marble color effect evaluation factor is at least one of: the number of the regions in which the marble color effect is created; the average size of the regions in which the marble color effect is created; and a difference in average color brightness between the regions in which the marble color effect is created and a region in which the marble color effect is not created.

The marble color effect evaluation system according to one embodiment of the present invention may quantitatively evaluate the marble color effect of the surface of the marbled molded product by determining an evaluation factor that may quantitatively determine the marble color effect.

According to one embodiment of the present invention, the marbled molded product to be evaluated in the marble color effect evaluation system may be a molded product produced by injection molding using a mold cavity having a smooth inner surface, or may be a molded product produced by injection molding using a mold cavity having a pattern formed on an inner surface thereof. Where the pattern on the inner surface for the marbled molded product to be evaluated is selected as described above, it is possible to quantitatively evaluate the marble color effect.

FIG. 4 is a schematic view showing the marble color effect evaluation system according to one embodiment of the present invention.

According to one embodiment of the present invention, the marble color effect evaluation system 100 may comprise a light source unit 10, an image-capturing unit 20, an image processing unit 30 and an evaluation factor determination unit 40.

According to one embodiment of the present invention, the light source unit 10 emits light onto the surface of a marbled molded product P at a predetermined angle. Specifically, the light source unit 10 emits light onto the surface of the marbled molded product while forming an angle with the surface of the marbled molded product P. Where the light source unit 10 emits light onto the surface of the marbled molded product P while forming an angle with the surface of the marbled molded product P as described above, it is possible to create an image that may confirm the marble color effect.

According to one embodiment of the present invention, the image-capturing unit 20 captures an image of light scattered from the surface of the molded product. Specifically, the image-capturing unit 20 may capture an image of light scattered from the surface of the marble molded product P. This image-capturing unit 20 may be a CCD camera. Where the image-capturing unit 20 captures the image of the scattered light as described above, it is possible to capture the image of light of the particles creating the marble color effect.

According to one embodiment of the present invention, one image-capturing unit 20 may be provided so that it may capture an image of light while moving along a virtual semicircular path in one side of the marbled molded product P. Where a single image-capturing unit 20 is provided so that it captures an image of light while moving along a virtual semicircular path in one side of the marbled molded product P as described above, it is possible to reduce the production cost for constructing the marble color effect evaluation system and minimize the image difference caused by the difference between two or more image-capturing units.

According to one embodiment of the present invention, a plurality of image-capturing units 20 are arranged along a virtual semicircular path so that they may all operate to capture an image of light. Where a plurality of image-capturing units 20 are arranged along a virtual semicircular path as described above so that they may all operate to capture an image of light as described above, it is possible to evaluate a large amount of molded product surfaces by shortening the time for image capturing.

According to one embodiment of the present invention, the marble color effect evaluation system comprises the image processing unit 30 configured to process the image captured by the image-capturing unit 20 in order to determine a boundary of a region in which the marble color effect is created on the surface of the molded product. Specifically, the image processing unit 30 may process an image to determine the boundary of the marble color region from the image captured by the image-capturing unit 20, and may be implemented as a predetermined processor. Where the marble color effect evaluation system comprises the image processing unit as described above, it is possible to clearly determine the boundary of a region in which the marble color effect is created, and it is possible to quantitatively compare a region in which the marble color effect is not created.

According to one embodiment of the present invention, the image processing unit 30 may determine the boundary of a region in which the marble color effect is created, by extracting a contrast value for each pixel from the captured image, determining that pixels each having a value equal to or greater than a predetermined reference value are boundary pixels forming the boundary of the region in which the marble color effect is created, and connecting the boundary pixels. Where the boundary of the region in which the marble color effect is created is determined as described above, it is possible to process the captured original image so that the boundary is clearly visible.

According to one embodiment of the present invention, the reference contrast value for determining the boundary of the region in which the marble color effect is created may differ depending on each color previously set. Where the image processing unit 30 sets a different reference value for each color of the marble color as described above, it is possible to process the captured image so that the boundary of the region in which the marble color effect is created is clearly visible.

FIG. 5(a) shows an example of an image before being processed by the image processing unit, and FIG. 5(b) shows an image obtained by processing the image of FIG. 5(a) by the image processing unit according to a predetermined reference.

For the marbled molded product that is the object of the image of FIG. 5, mica was used as the fine pigment particles, and the inner surface of the mold cavity, on which the pattern was formed, had an average roughness (Ra) of 1.12 μm. The marbled molded product produced under these conditions was used as a reference.

Referring to FIG. 5, in the image of FIG. 5(a) before being processed by the image processing unit, it was confirmed that the boundary of the region in which the marble color effect is created is unclear. In contrast, in the image of FIG. 5(b) obtained by processing the image of FIG. 5(a) by the image processing unit, it was confirmed that the boundary of the region in which the marble color effect is created is clearly visible.

According to one embodiment of the present invention, the marble color effect evaluation system comprises the evaluation factor determination unit 40 for determining a marble color effect evaluation factor from the image processed by the image processing unit. By comprising the evaluation factor determination unit as described above, it is possible to clearly distinguish the boundary of the region in which the marble color effect is created.

According to one embodiment of the present invention, the marble color effect evaluation factor is at least one of: the number of regions in which the marble color effect is created; the average size of the regions in which the marble color effect is created; and a difference in average color brightness between the regions in which the marble color effect is created and a region in which the marble color effect is not created. By selecting the marble color effect evaluation factor from those described above, it is possible to clearly distinguish the boundary of the region in which the marble color effect is created. Specifically, the evaluation factor determination unit 40 may determine, as the marble color effect evaluation factor, at least one of the number of regions (marbled regions) in which the marble color effect is created, the average size of the marbled regions, and the difference in average color brightness between the marbled regions and the background (non-marbled region) excluding the regions in which the marble color effect is created, from the image processed by the image processing unit 30, and determination of the marble color effect evaluation factor may be executed by a predetermined processor.

According to one embodiment of the present invention, the evaluation element determination unit may determine the marble color effect evaluation factor for each color of the region in which the marble color effect is created. By determining the marble color effect evaluation factor as described above, it is possible to improve the effect of clearly distinguish the boundary of the region in which the marble color effect is created.

### MODE FOR INVENTION

Hereinafter, the present invention will be described in detail with reference to examples. However, the examples according to the present invention may be modified into various different forms, and the scope of the present invention is not construed as being limited to the examples described below. The examples in the present specification are provided to more completely describe the present invention to those skilled in the art.

### Example 1

A mixture, obtained by mixing a thermoplastic resin composed of a mixture of polycarbonate (PC) and acrylonitrile-butadiene-styrene (ABS) with mica as fine pigment particles, was injection-molded in a mold cavity having a pattern formed on the inner surface thereof, thereby producing a marbled molded product as an injection-molded product. The marbled molded product was produced by injection molding in a mold in which the inner surface of the mold cavity, on which the pattern was formed, had an average roughness (Ra) of 1.12 μm.

### Example 2

A marbled molded product was produced in the same manner as in Example 1, except that it was produced by injection molding in a mold in which the inner surface of the mold cavity, on which the pattern was formed, had an average roughness (Ra) of 3.15 μm.

### Example 3

A marbled molded product was produced in the same manner as in Example 1, except that it was produced by injection molding in a mold in which the inner surface of the mold cavity, on which the pattern was formed, had an average roughness (Ra) of 6.30 μm.

### Comparative Example 1

A mixture, obtained by mixing a thermoplastic resin composed of a mixture of polycarbonate (PC) and acrylonitrile-butadiene-styrene (ABS) with mica as fine pigment particles, was injection-molded in a mold in which the inner surface of a mold cavity had an average roughness (Ra) of 100 nm, thereby producing a molded product.

### Comparative Example 2

A marbled molded product was produced in the same manner as in Example 1, except that it was produced by injection molding in a mold in which the inner surface of the mold cavity, on which the pattern was formed, had an average roughness (Ra) of 12.6 μm.

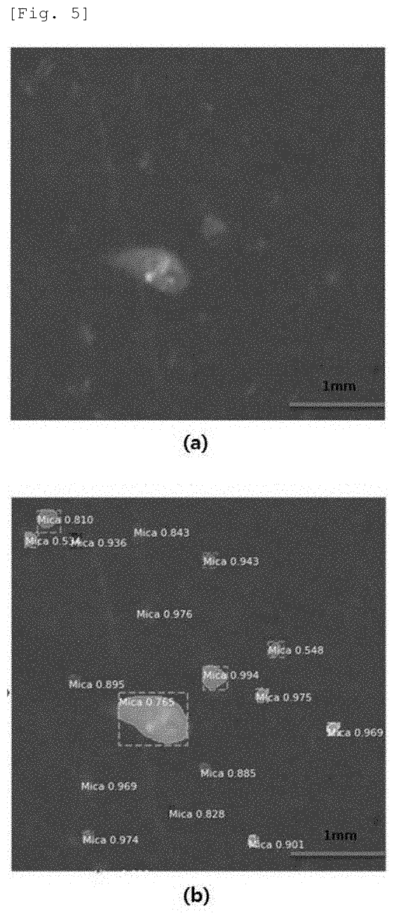

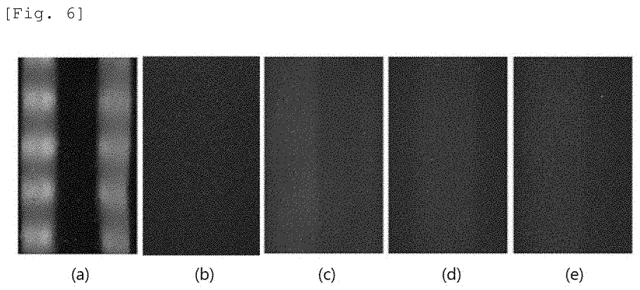

FIGS. 6(a), 6(b), 6(c), 6(d) and 6(e) show images of specimens of Comparative Example 1, Comparative Example 2, Example 1, Example 2 and Example 3, respectively, captured by the image-capturing unit 20 of the marble color effect evaluation system 100 according to one embodiment of the present invention.

Specifically, light generated from the light source unit 10 was incident on the surface of each of the marbled molded products of Comparative Examples 1 and 2 and Examples 1 to 3 while forming an angle with the surface. Following this, an image of light scattered from the surface of each of the molded products was captured by the image-capturing unit 20. The image captured by the image-capturing unit 20 was processed by the image processing unit 30 in order to determine the boundary of the marbled region on the surface of each molded product. From the processed image, marble color effect evaluation factors, including the number of the marbled regions, the average size of the marbled regions, and the difference in average color brightness between the marbled regions and a non-marbled region, were determined by the evaluation factor determination unit 40.

Table 1 below shows the number of the marbled regions, the number of the marbled regions per unit area, the average size of the marbled regions, the difference in average color brightness between the marbled regions and the background (non-marbled region) excluding the marbled regions, and the pencil hardness of the surface, for the molded products of Comparative Examples 1 and 2 and Examples 1 to 3.

Specifically, Table 1 below shows the number of the marbled regions, the number of the marbled regions per unit area, the average size of the marbled regions, the difference in average color brightness between the marbled regions and the background excluding the marbled regions (the difference in average color brightness between the marbled regions and the non-marbled region), and the pencil hardness of the surface, for the specimens of the molded products of Comparative Examples 1 and 2 and Examples 1 to 3.

TABLE 1

| | Comparative | Comparative | Example | Example | Example |
|---|---|---|---|---|---|
| | Example 1 | Example 2 | 1 | 2 | 3 |
| Number | 114 | 73 | 320 | 204 | 132 |
| of marbled | | | | | |
| regions | | | | | |
| Number of | 3.6 | 2.3 | 10.0 | 6.4 | 4.1 |
| marbled | | | | | |
| regions per | | | | | |
| unit area | | | | | |
| (number/cm²) | | | | | |
| Average size | 345 | 330 | 359 | 334 | 293 |
| (μm) of | | | | | |
| marbled | | | | | |
| regions | | | | | |
| Difference | 8.17 | 24.6 | 11.74 | 15.68 | 21.37 |
| in average | | | | | |
| color | | | | | |
| brightness | | | | | |
| Δ*ab | | | | | |
| between | | | | | |
| marbled | | | | | |
| regions and | | | | | |
| non-marbled | | | | | |
| region | | | | | |
| Pencil | B | 2H | HB | H | 2H |
| hardness of | | | | | |
| surface | | | | | |
| (measurement | | | | | |
| conditions: | | | | | |
| 500 g and | | | | | |
| 300 mm/min) | | | | | |

It was confirmed that, in the case of the marbled molded products of the Examples, the number of the confirmed marbled regions per unit area, and the difference in average color brightness between the marbled regions and the non-marbled region were all improved, suggesting that the marble color effect was more effectively visible.

In contrast, it was confirmed that, in the case of the marbled molded product of Comparative Example 1, the hardness was excessively low, and the number of the confirmed marbled regions per unit area, and the difference in average color brightness between the marbled regions and the non-marbled region were all reduced. Furthermore, it was confirmed that, in the case of Comparative Example 2, the number of the confirmed marbled regions per unit area was reduced.

In addition, it was confirmed that the surfaces of the marbled molded products of the Examples had higher pencil hardness than that of Comparative Example 1. That is, it was confirmed that the durability of the marbled molded products produced of the Examples of the present invention was ensured so that damage to the marble color effect could be minimized. However, it was confirmed that, in the case of Comparative Example 2, the hardness increased, but the number of the confirmed marbled regions per unit area was reduced, and thus the marble color effect was degraded.

Furthermore, it was confirmed that, according to the marble color effect evaluation factors of the Comparative Examples and the Examples, in which the evaluation factors of the surfaces were determined by the marble color effect evaluation system, it was possible to determine, for each marbled molded product, the number of the marbled regions, the number of the marbled regions per unit area, the average size of the marbled regions and the difference in average color brightness between the marbled regions and the background excluding the marbled regions, and thus it was possible to quantitatively evaluate the marble color effect.

Therefore, according to the marbled molded product and marble color effect evaluation system of the present invention, it is possible to provide a marbled molded product in which a marble color may be effectively formed and which may maintain a high surface hardness, and it is possible to provide a marble color effect evaluation system capable of objectively and quantitatively evaluating the marble color effect of the marbled molded product.

### DESCRIPTION OF REFERENCE NUMERAL

100: Evaluation system
10: Light source unit
20: Image-capturing unit
30: Image processing unit
40: Evaluation factor determination unit

1. A marbled molded product which is an injection-molded product of a mixture, the mixture comprising:
a thermoplastic resin comprising one selected from the group consisting of polycarbonate, acrylonitrile-butadiene-styrene, polybutylene terephthalate, polypropylene, and combinations thereof; and
fine pigment particles,
wherein a pattern forming a texture is formed on a surface of the injection-molded product.

2. The marbled molded product of claim 1, wherein the pattern which is formed on the surface of the injection-molded product has a depth of 100 nm to 1,000 μm.

3. The marbled molded product of claim 1, wherein an average roughness (Ra) of the surface of the injection-molded product, which has the pattern formed thereon, is 1.12 μm to 12.5 μm.

4. The marbled molded product of claim 1, wherein the pattern has a depth of 10 μm to 50 μm and a width of 50 μm to 300 μm, and the texture formed by the pattern is a hairline texture.

5. The marbled molded product of claim 1, wherein the pattern has a depth of 8 μm to 12 μm and a width of 50 μm to 100 μm, and the texture formed by the pattern is a woven texture.

6. The marbled molded product of claim 1, wherein the pattern has a depth of 50 μm to 100 μm, and the texture formed by the pattern is a leather texture.

7. A system for evaluating a marble color effect of a marbled molded product which is an injection-molded product of a mixture, the mixture comprising:
a thermoplastic resin comprising one selected from the group consisting of polycarbonate, acrylonitrile-butadiene-styrene, polybutylene terephthalate, polypropylene, and combinations thereof; and
fine pigment particles,
wherein the system comprises:
a light source unit that emits light onto a surface of the injection-molded product while forming an angle with the surface of the injection-molded product;
an image-capturing unit that captures an image of light scattered from the surface of the injection-molded product;
an image processing unit that processes the image captured by the image-capturing unit in order to determine boundaries of regions in which the marble color effect is created on the surface of the injection-molded product; and
an evaluation factor determination unit that determines a marble color effect evaluation factor from the image processed by the image processing unit, and
wherein the marble color effect evaluation factor is at least one of: the number of the regions in which the marble color effect is created; the average size of the regions in which the marble color effect is created; and a difference in average color brightness between the regions in which the marble color effect is created and a region in which the marble color effect is not created.

8. The system of claim 7, wherein the evaluation factor determination unit determines the marble color effect evaluation factor for each color of the regions in which the marble color effect is created.
